(19) United States
(12) Patent Application Publication
(10) Pub. No.: US 2020/0279298 A1
(43) Pub. Date: Sep. 3, 2020

(54) TARGETED ADS BASED ON USER TO-DO AND SHOPPING LISTS

(71) Applicant: Google LLC, Mountain View, CA (US)

(72) Inventors: Leslie Chiang, Santa Clara, CA (US); Matthew Kovinsky, San Francisco, CA (US)

(21) Appl. No.: 15/609,849

(22) Filed: May 31, 2017

Related U.S. Application Data
(63) Continuation of application No. 11/987,094, filed on Nov. 27, 2007, now abandoned.

(51) Int. Cl. G06Q 30/02; G06Q 10/10

(52) U.S. Cl. CPC G06Q 30/0264; G06Q 30/0633; G06Q 10/109; G06Q 30/0255

(57) ABSTRACT

The present invention relates to systems and methods for providing advertisements on websites. In an embodiment, a method for providing an advertisement on a website includes obtaining user-sourced information regarding a future event, analyzing the content of the user-sourced information to identify a characteristic of at least one of a product or service relevant to the future event, comparing the characteristic to a descriptor associated with a list-based advertisement, and selecting the list-based advertisement for display on a website visited by the user when the characteristic matches the descriptor associated with the advertisement.

### BACKGROUND

### Field of the Invention

The present invention relates to targeted advertisements.

### Related Art

Targeting an advertisement to a desired audience often increases the likelihood that the advertisement will be successful in generating commercial activity for the advertiser. Advertisements are often targeted differently based on the medium through which they are delivered. For example, television advertisements are often targeted based on the content of the television program. Information about the television program is used to determine information about the audience. However, the task of determining information about an audience, in television and other mediums, can be complex and difficult to automate. Although determining audience information based on programming content individually on a case-by-case basis may be practical for some advertising mediums, determining audience information in such a manner for advertisements communicated over the Internet can be time consuming. Therefore, providing relevant Internet advertisements to users visiting an Internet website can become inefficient and costly.

Thus, what is needed is methods and systems for reducing the costs and improving the efficiency of providing advertisements on a website that are relevant to a user visiting the website.

### SUMMARY

The present invention relates to systems and methods for providing advertisements on websites. In an embodiment, a method for providing an advertisement on a website includes obtaining user-sourced information regarding a future event, analyzing the content of the user-sourced information to identify a characteristic of at least one of a product or service relevant to the future event, comparing the characteristic to a descriptor associated with a list-based advertisement, and selecting the list-based advertisement for display on a website visited by the user when the characteristic matches the descriptor associated with the advertisement.

In another embodiment, a system for providing an advertisement on a website includes a user-sourced information database that stores user-sourced information regarding a future event, a content analyzer that analyzes the user-sourced information from the user-sourced information database and determines a characteristic of at least one of a product or service relevant to the future event, an ad database that stores a list-based advertisement having an associated descriptor, and an ad server that selects the list-based advertisement from the ad database for display on a website visited by the user when the characteristic matches the associated descriptor.

Further embodiments, features, and advantages of the invention, as well as the structure and operation of the various embodiments of the invention are described in detail below with reference to accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIGS. 1 and 2 illustrate systems for providing advertisements.

FIG. 3 illustrates a system for providing advertisements, according to an embodiment of the present invention.

FIGS. 4-5 show flowcharts illustrating methods for providing advertisements, according to an embodiment of the present invention.

FIG. 6 shows an advertisement, according to an embodiment of the present invention.

FIG. 7 illustrates a to-do list, according to an embodiment of present invention.

FIG. 8 illustrates a shopping list, according to an embodiment of present invention.

FIG. 9 shows a flowchart illustrating a method for providing advertisements, according to an embodiment of the present invention.

FIG. 10 is a block diagram of an exemplary computer system useful for implementing the present invention.

### DETAILED DESCRIPTION OF EMBODIMENTS

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional-fields in which the invention would be of significant utility.

Embodiments described herein refer to advertisements being provided on a website. In providing an advertisement for a website, an ad server typically may choose from a variety of advertisements stored in an ad database. In choosing between different advertisements, an ad server may select an advertisement that is relevant to a user visiting the website. As would be apparent to those skilled in the relevant art(s), advertisements that are relevant to a user are typically more effective, i.e., have a higher likelihood of being selected by the user, when compared to advertisements that are not relevant to the user.

Advertisements, as described herein, may refer to any type of advertisement that may be displayed while a user is visiting a website. For example and without limitation, an advertisement may be a text advertisement, an image advertisement, a video advertisement, an audio advertisement, or a multimedia advertisement.

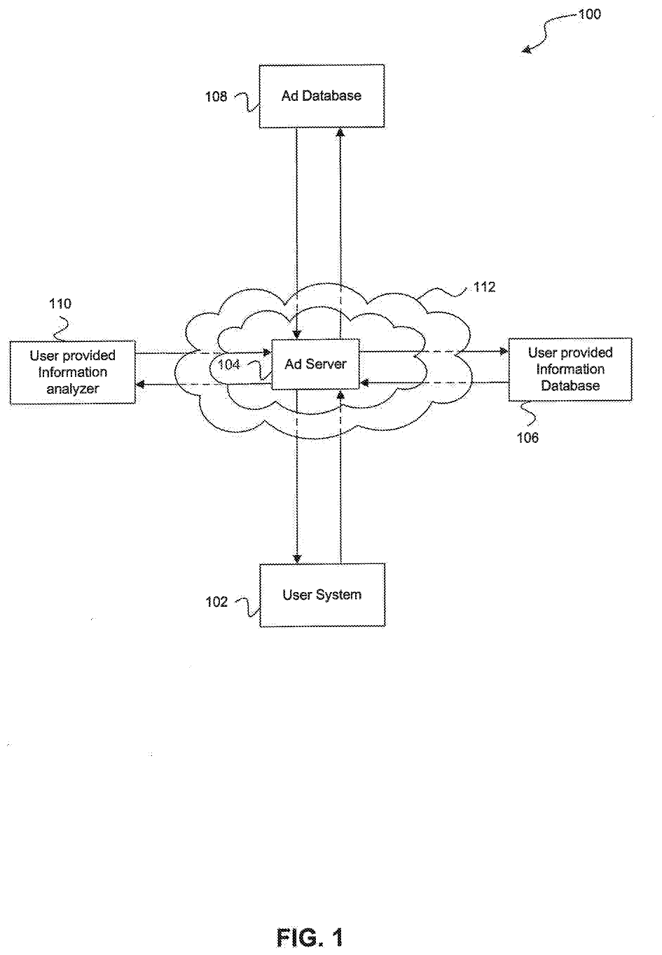

Relevant advertisements may be selected from an ad database in a variety of ways. For example, FIG. 1 shows an example system 100 for providing advertisements on a website based on information provided by a user. The information provided is used to determine one or more interests of the user. The interests of the user, then, are used to select relevant advertisements to be provided on a website.

System 100 includes a user system 102, an ad server 104, a user provided information database 106, an ad database 108, and a user provided information analyzer 110. As shown in FIG. 1, user system 102, user provided information database 106, ad database 108, and user provided information analyzer 110 are all coupled to ad server 104. The connections may be direct or indirect, such as over a network 112. Ad server 104 is configured to provide advertisements on a website that the user is visiting. Ad server 104 may provide advertisements in response to requests for advertisements from the user, user system 102, and/or a publisher of the website. Moreover, ad server 104 may also be configured to allow elements of system 100 to interact with each other. For example, ad server 104 may allow user provided information analyzer 110 to analyze information stored in user provided information database 106. Alternatively, user provided information analyzer 110 may be directly coupled to user provided information database 106. Ad server 104 may also be configured to provide websites requested by the user to user system 102.

User system 102 is configured to allow the user to access the Internet or other communication network. Thus, through user system 102, the user may visit one or more websites. In visiting a website, user system 102 requests the website from a server. In response to the request, the website is downloaded to and displayed on user system 102. An advertisement provided on the website is displayed on user system 102 when the user visits the website. The advertisement may be embedded within the website or otherwise displayed. In an embodiment, ad server 104 may be configured to operate as the server and service requests for websites from user system 102.

User provided information is stored in user provided information database 106. Information stored in user provided information database 106 may be collected in a variety of ways. For example, the user may be queried for information in the form of a survey. Additionally or alternatively, a user may provide information by performing a search. For example, a user may visit a search engine. In providing search terms to the search engine, the search terms may also be stored in user provided information database 106. Ad server 104 may be configured to receive user provided information and to transmit that information to user provided information database 106.

Ad database 108 is configured to store advertisements that may be displayed on websites. Ad database 108 may also be configured to store entries associated with each of the stored advertisements. The stored entries may include descriptors that are used to compare the content of the advertisement with information associated with one or more interests of the user.

User provided information analyzer 110 is configured to analyze information stored in user provided information database 106. In an embodiment, user provided information analyzer 110 is configured to analyze input information and identify one or more characteristics of at least one product or service relevant to the information, The identified characteristics, then, are provided to ad server 104. Ad server 104 selects an advertisement from ad database 108 that has descriptors that match the identified characteristics. Ad server 104 provides the selected advertisement on the website, Thus, user provided information analyzer 110 takes generally unprocessed data related to one or more interests of the user and identities one or more characteristics that can be used to search ad database 108 for advertisements relevant to the user's interests.

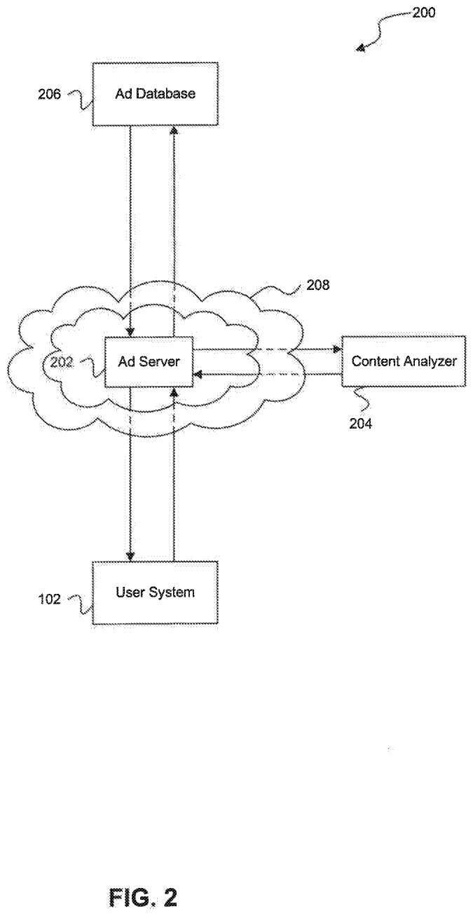

As described above, system 100 provides a system for providing advertisements on a website that are relevant to the interests of the user. However, in cases where no information is provided by the user, advertisements are often provided that are not relevant to the user. FIG. 2 shows an exemplary system 200 for providing advertisements on a website that are relevant to a user's interests. In contrast to system 100 shown in FIG. 1, system 200 determines one or more interests of the user based on the website that the user is visiting.

System 200 includes an ad server 202, a content analyzer 204, an ad database 206, and user system 102. Ad server 202 is configured to interact with user system 102, content analyzer 204, and ad database 206. Connections between ad server 202 and user system 102, content analyzer 204, and ad database 206 may be direct or indirect, such as over a network 208. Similar to ad server 104 described with reference to system 100 shown in FIG. 1, ad server 104 is configured to search ad database 206 based on identified characteristics. In contrast to ad server 104, ad server 202 is configured to search ad database 206 for relevant advertisements based on characteristics identified by content analyzer 204 instead of user provided information analyzer 110.

Content analyzer 204 is configured to analyze websites and identify one or more characteristics of at least one product or service relevant to the content of the website. For example, ad server 202 may input the website that the user is visiting to content analyzer 204. Content analyzer 204 analyzes the website and identifies one or more characteristics associated with the website. In response to a request for an advertisement, ad server 202 queries content analyzer 204 for the identified characteristics and searches ad database 206 for advertisements that have one or more descriptors that match the identified characteristics. For more information regarding the operation of content analyzer 204, please refer to Patent Publication No. US 2004/0059708 published Mar. 25, 2004 to Dean et al., which is incorporated by reference herein in its entirety.

Thus, by analyzing information provided by a user and/or the content of a website visited by the user, one or more interests of a user may be determined. Although such advertisements are more likely to be relevant to the user's interest, an ad server often cannot determine whether such an interest is indicative of a future event. For example, if it is determined that a user is interested in fishing, an ad server may provide an advertisement that advertises fishing related products without knowing whether the user intends to go fishing. In such a case, advertisements selected based on their relevance to one or more interests of a user may not be as effective as advertisements selected based on their relevance to one or more future events.

In embodiments described herein, however, advertisements may be selected based on their relevance to user-sourced information regarding a future event in addition to or instead of their relevance to one or more interests of a user. In an embodiment, user-sourced information may include user-provided information. Additionally or alternatively, user-sourced information may include information not expressly provided by the user. For example, and without limitation, such information may include a set of planned events stored on a computer of the user. In such an embodiment, the set of planned events is not expressly provided by the user, but rather is obtained through appropriate interaction between a server and the user's computer. In a further embodiment, the server may be configured to obtain such information only with the user's permission.

In an embodiment, user-sourced information regarding a future event includes information regarding an event that the user intends, desires, and/or expects to happen. For example, such an event may be a fishing trip.

Since the information is obtained directly or indirectly from the user, i.e., it is user-sourced, future events contained therein may be considered relevant to the user. As would be appreciated by those skilled in the relevant art(s), user-sourced information may include other types of information without departing from the scope and spirit of the invention.

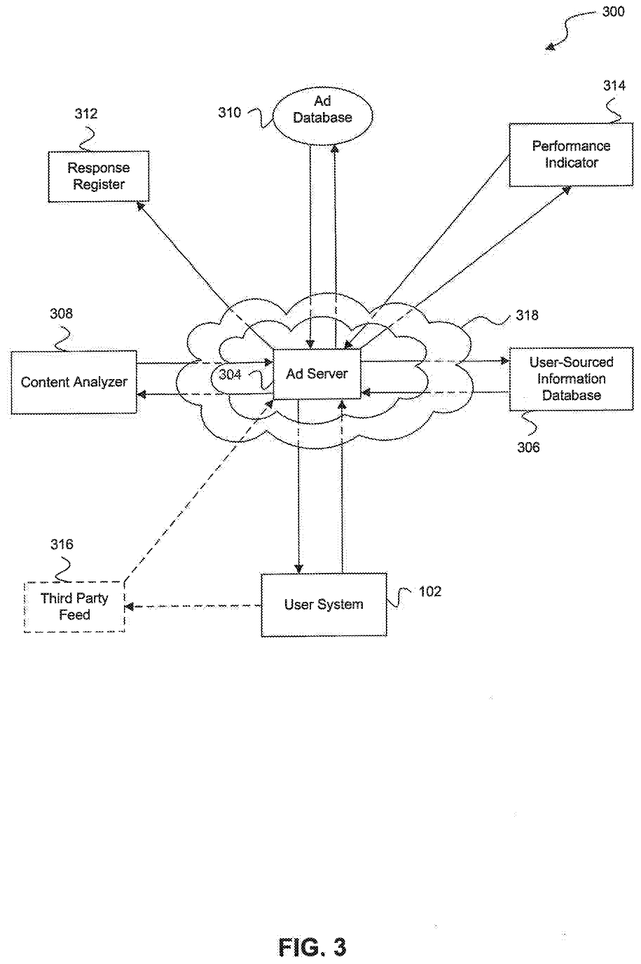

FIG. 3 shows an exemplary system 300 for providing an advertisement on a website, according to an embodiment of the present invention. System 300 includes user system 102, an ad server 304, a user-sourced information database 306, a content analyzer 308, an ad database 310, a response register 312, and a performance indicator 314. System 300 also optionally includes a third-party feed 316. Ad server 304 is configured to select an advertisement for display on a website visited by the user from ad database 310.

Content analyzer 308 is configured to receive information and identify one or more characteristics of at least one product or service relevant to the future event. For example, content analyzer 308 may analyze information stored in user-sourced information database 306 and identify one or more associated characteristics. Methods of obtaining user-sourced information will be described in further detail below. In an embodiment, content analyzer 308 also includes, but is not limited to, the functionality of content analyzer 204 described with reference to system 200, shown in FIG. 2. Ad database 310 is generally similar to ad database 206 described with reference to FIG. 2. However, ad database 310 may also be configured to store descriptors in entries associated with stored advertisements that are configured to be compared to characteristics identified by content analyzer 308. In an embodiment, each advertisement stored in ad database 310 is analyzed by content analyzer 308, in a manner similar to the analyses of user-provided information or a web page. Identified characteristics associated with each advertisement may be stored as descriptors in the entry associated with each respective advertisement in ad database 310.

As would be appreciated by those skilled in the relevant art(s), elements of system 300 may also be directly connected instead of or in addition to being coupled through ad server 304. For example, content analyzer 308 may be directly connected to user-sourced information database 306. The elements and operation of system 300 will be described in further detail with respect to flowcharts 400 and 500.

As would be appreciated by those skilled in the relevant art(s), each of the elements of system 300 may be implemented as a server or otherwise as hardware, software, firmware, or any combination thereof. Each element of system 300 may be coupled to other elements of system 300 through the use of a communication network 318 such as the Internet. Network 318 can be any network or combination of networks that can carry data communication, and may be referred to herein as a computer network. Such network 318 can include, but is not limited to, a local area network, medium area network, and/or wide area network such as the Internet. Network. 318 can support protocols and technology including, but not limited to, World Wide Web protocols and/or services. Intermediate web servers, gateways, or other servers may be provided between components of system 300 depending upon a particular application or environment. Moreover, one or more of the elements of system 300 may include one or more sub-elements. In such an embodiment, each of the sub-elements may be coupled together through wired and/or wireless connections.

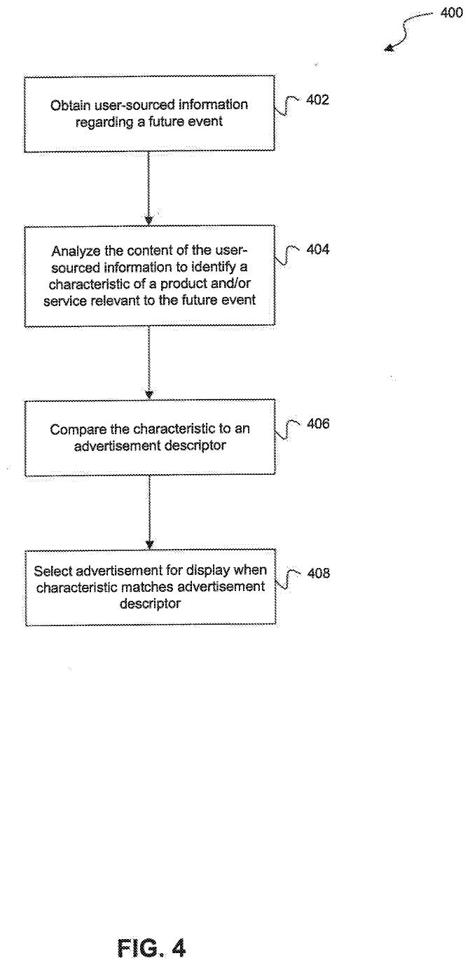

As shown in FIG. 4, an exemplary method 400 for providing an advertisement on a website is provided, according to an embodiment of the present invention. As would be apparent to those skilled in the relevant art(s), such a method may be automated through the use of hardware, software, firmware, or any combination thereof. Method 400 will be described with reference to the embodiment in which advertisements are provided to a user interacting with system 300 shown in FIG. 3, but is not limited in that regard.

Method 400 begins with step 402. In step 402, user-sourced information regarding a future event is obtained. For example, in FIG. 3, ad server 304 may obtain user-sourced information regarding a future event from user system 102. Ad server 304 may store the user-sourced information in user-sourced information database 306.

In an embodiment, user-sourced information regarding a future event is obtained from information entered by the user at user system 102. The information entered by the user may be for the purpose of receiving relevant advertisements. For example, the user may complete a questionnaire or survey from which information regarding a future event may be directly or indirectly obtained. Such a questionnaire may be received by ad server 304.

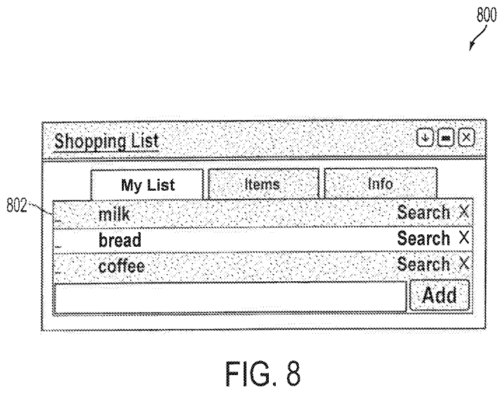

Additionally or alternatively, the obtained information regarding a future event may be entered by the user at user system 102 for other purposes. For example, the user may use user system 102 to maintain a to-do list, shopping list, wish list, task list, and/or other type of structure that stores information regarding future events relevant to the user. For example, FIGS. 7 and 8 show an exemplary to-do list 700 and an exemplary shopping list 800, respectively, that may be stored at user system 302.

Additionally or alternatively, the information regarding future events may be included in a calendar or other management tool that provides planning tools for future events maintained on user system 102. For example, the user may maintain a calendar through the Microsoft Outlook software application distributed by the Microsoft Corporation of Redmond, Wash. Information regarding a future event may be obtained from information entered in the calendar. Information obtained from such an application may or may not be entered by the user. For example, an individual, group of individuals, or other entity associated with the user in addition to or instead of the user may enter an event on the user's calendar. Information in such a calendar, entered by the user and/or an associated entity, may be received by ad server 304 and stored in user-sourced information database 306.

Additionally or alternatively, user-sourced information regarding a future event may be obtained from a third party. In such an embodiment, the information may or may not be stored at user system 102. In an embodiment, the information is stored at a third party storage. For example, the user may access the Internet from user system 302 and may transmit information regarding a future event to a search engine or other website. For example, the user may transmit the information to a website affiliated with the Yahoo! search engine provided by Yahoo! Inc. of Sunnyvale, Calif. The information transmitted to the third party may include a list, schedule, calendar, or other structure that stores information regarding future events relevant to the user. This information may be retrieved via a third party feed. As shown in FIG. 3, information from third-party feed 316 may be retrieved by ad server 304.

In an embodiment, the user-sourced information regarding a future event is dynamic. For example, the user may update to-do list 700 as tasks are completed. In a further embodiment, information regarding future events derived from completed tasks may be determined to be no longer relevant. Alternatively, a task or other entry type (e.g., an item on a shopping list) may be determined to be representative of a recurring future event, and thus still relevant even though such an entry may be marked as being completed or otherwise having already occurred.

In the embodiment in which the information is dynamic, ad server 304 may periodically receive the user's to-do list from system 302. Updated information may be stored in user-sourced information database 306 along with or instead of previously obtained information.

In an embodiment, information that is entered for purposes other than receiving relevant advertisements may be received at ad server 304 only through appropriate permission by the user. Additionally or alternatively, the user may set intermediate permissions that allow ad server 304 to receive information from certain sources while restricting access to other sources.

In step 404, the content of the user-sourced information is analyzed to identify one or more characteristics of a product and/or service relevant to the future event. For example, ad server 304 may access user-sourced information database 306 to retrieve to-do list 700 and/or shopping list 800. Ad server 304 transmits the information regarding a future event to content analyzer 308. Content analyzer 308 analyzes to-do list 700 and/or shopping list 800 to determine one or more characteristics of a product and/or service relevant to a future event described in to-do list 700 and/or shopping list 800.

In an embodiment, the characteristic may include a product and/or service to be purchased by the user, a classification and/or feature of a product and/or service to be purchased by the user, and/or a location of the user. For example, content analyzer 308 may analyze to-do list 700 and determine from an entry 702 of to-do list 700 a characteristic to be groceries (i.e., a classification of a product to be purchased by the user). Additionally or alternatively, content analyzer 308 may determine from an entry 802 of shopping list 800, a characteristic to be milk (i.e., a product to be purchased by the user). As would be appreciated by those skilled in the relevant art(s), characteristics relevant to future events may include other types of characteristics not listed above without departing from the scope and spirit of the present invention.

In step 406, the characteristic is compared to an advertisement descriptor. For example, ad server 304 may compare groceries, i.e., one of the determined characteristics to descriptors associated with advertisements stored in ad database 310.

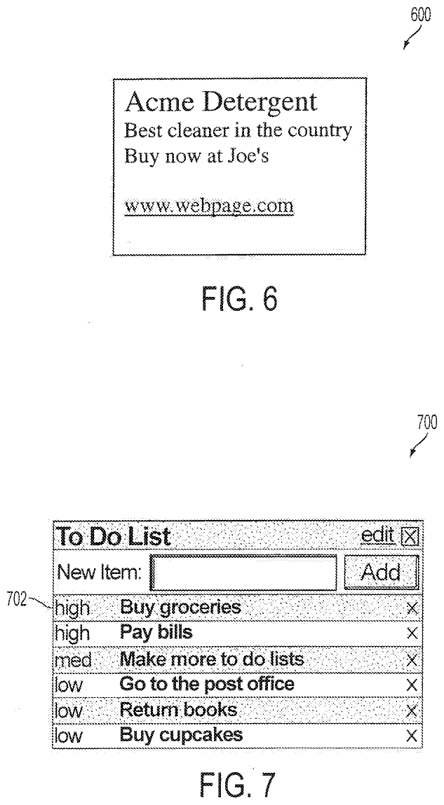

In step 408, an advertisement is selected for display when the characteristic matches the advertisement descriptor. For example, FIG. 6 shows an advertisement 600 for a detergent. Advertisement 600 may have groceries as an associated descriptor. In such an embodiment, ad server 304 may select advertisement 600 for display since the associated descriptor matches an identified characteristic (e.g., groceries).

In alternate embodiments, a match may be determined even though the descriptor is not identical to the identified characteristic. For example, advertisements stored in ad database 310 that have descriptors that are related to groceries (e.g., vegetables) may be selected for display.

In an embodiment, multiple characteristics may be matched so that an advertisement may be displayed. For example, ad server 304 may find multiple advertisements stored in ad database 310 having a descriptor that matches groceries. In such an embodiment, ad server 304 may select an advertisement that matches an additional identified characteristic associated with to-do list 700 and/or shopping list 800. For example, ad server 304 may select an advertisement that has a location descriptor that matches a location of the user. In an embodiment, a location associated with an advertisement is determined by inputting the advertisement to content analyzer 308, which determines the associated location as one of the identified characteristics associated with the advertisement. Similarly, the location of the user may determined by inputting information regarding a future event (e.g., to-do list 700 and/or shopping list 800) into content analyzer, which determines the location of the user as one of the identified characteristics. Comparing location related descriptors to location related identified characteristics may be done independently of or in tandem with other comparisons.

As described above, a match may be determined even in cases where the descriptor of the advertisement is not identical to a characteristic associated with the information regarding a future event. In the embodiment in which the location associated with the advertisement and user is matched to select an advertisement for display, a match may be determined when the location associated with the advertisement is within a specified distance of the location associated with the user. The specified distance may be determined by the user or ad server 304.

As described above, user-sourced information regarding a future event is analyzed to identify one or more characteristics of at least one product or service relevant to the future event. In alternate embodiments the user-sourced information may be associated with multiple future events. In those embodiments, characteristics may be determined for each future event and an advertisement may be chosen based on the highest number of descriptors that match the identified characteristics. Multiple advertisements may be selected in a similar manner. Multiple future events may be determined from a single source of user-sourced information (e.g., a single to-do list) or multiple sources of user-sourced information (e.g., one or more to-do lists and/or shopping lists).

In an embodiment, ad server 304 may receive a request from the user for advertisements relevant to information regarding a future event. In a further embodiment, the request from the user may be a time-based request that corresponds to a date of a future event. For example, the user-sourced information may indicate that the user has a friend whose birthday is in a week. In response to a request from the user for advertisements relevant to the friend's birthday, ad server 304 may provide the user with relevant advertisements until the friend's birthday occurs. Ad server 304 may stop providing advertisements relevant to the friend's birthday after the birthday occurs.

In an alternative embodiment, ad server 304 may receive a request from a publisher of a website for advertisements relevant to information regarding future events associated with users that visit the website. For example, the publisher of the website may determine that advertisements relevant to the interests of users visiting the website, determined through user provided information, suitable analysis of the website, or otherwise, will not be effective. In such an embodiment, advertisements relevant to future events associated with the users that visit the website may be requested by the publisher.

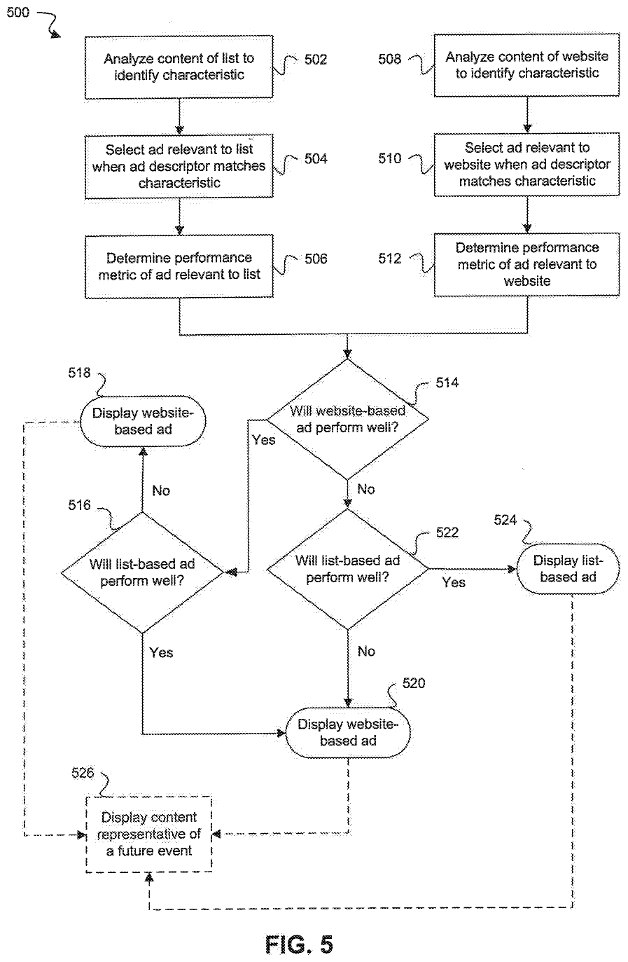

As shown in FIG. 5, an exemplary method 500 for providing an advertisement on a website is provided, according to an embodiment of the present invention. As would be apparent to those skilled in the relevant art(s), such a method may be automated through the use of hardware, software, firmware, or any combination thereof. Method 500 will be described with reference to the embodiment in which advertisements are provided to a user who is visiting a website through suitable interaction with system 300 shown in FIG. 3, but is not limited in that regard.

Method 500 begins with step 502. In step 502, the content of a list or other information regarding a future event is analyzed to identify one or more characteristics. In an embodiment, step 502 is substantially similar to step 404 described with reference to method 400 described above. For example, content analyzer 308 may identify one or more characteristics of at least one product or service relevant to future event(s) described within to-do list 700 and/or shopping list 800.

In step 504, a list-based advertisement is selected when one or more advertisement descriptors match one or more identified characteristics. In an embodiment, step 504 is substantially similar to step 408 described with reference to method 400 described above. For example, ad server 304 may select advertisement 600 because its associated descriptor matches an identified characteristic.

In step 506, a performance metric indicative of the success of the list-based advertisement when displayed on the website is determined. For example, in FIG. 3, performance indicator 314 may determine a performance metric indicative of the success of the list-based advertisement (e.g., advertisement 600).

In an embodiment, performance indicator 314 determines the performance metric through suitable interaction with response register 312. As described above, response register 312 is configured to register the response of the user to different advertisements. Thus, performance indicator 314 may query response register 312 to retrieve previous responses of the user to the list-based advertisement. In an embodiment, if the list-based advertisement has never been provided to the user or only provided to the user a relatively few number of times, so that a meaningful performance metric cannot be determined, the performance metric may be set to a default value or may be determined based on responses from different users.

in an embodiment, a response may be whether the user selects the list-based advertisement and/or whether the user does not select the advertisement. In a further embodiment, the performance metric is indicative of a probability that the user will select the list-based advertisement. As would be appreciated by those skilled in the relevant arts), performance indicator 314 may employ one of many different algorithms to determine the performance metric. For example, performance metric 314 may be configured to assign more weight to recent responses compared to older responses.

In step 508, the content of the website is analyzed to identify a characteristic of at least one product or service relevant to the content of the website. For example, ad server 304 may input the website into content analyzer 308 that identifies one or more associated characteristics. As described with reference to FIG. 2 above, characteristics of a website may be indicative of one or more interests of the user who visits the website.

In step 510, an advertisement relevant to the website is selected when the descriptor of the advertisement matches one or more identified characteristics associated with the website. For example, ad server 304 may select a website-based advertisement from ad database 310 when the descriptor of the advertisement matches one or more identified characteristics associated with the website.

In step 512, a performance metric indicative of the success of the website-based advertisement is determined. For example, performance indicator 314 may determine the performance metric associated with the website-based advertisement through suitable interaction with response register 316 in a manner substantially similar to the determination of the performance metric associated with the list-based advertisement described in step 506 above.

Thus, steps 502-512 of method 500 result in the selection of an advertisement relevant to a future event (e.g., the list-based advertisement) and an advertisement relevant to one or more interests of the user (e.g., the website-based advertisement) and the determination of a performance metric associated with each advertisement indicative of each of their success when displayed on the website.

In decision step 514, it is determined whether the website-based advertisement will perform relatively well when displayed on the website. For example, ad server 304 may query performance indicator 314 to retrieve the performance metric associated with the website-based advertisement.

in an embodiment, ad server 304 determines whether the website-based advertisement will perform relatively well by comparing the associated performance metric with a threshold. If the performance metric exceeds the threshold, ad server 304 may determine that the website-based advertisement will perform relatively well, The threshold may be indicative of an average or other statistical computation of performance metrics of some or all website-based advertisements, some or all list-based advertisements, or other types of advertisements. As would be appreciated by those skilled in the relevant art(s), whether the website-based advertisement will perform relatively well may be determined in other ways without departing from the scope and spirit of the invention.

If it is determined that the website-based advertisement will perform relatively well when displayed on the website, step 516 is reached. In decision step 516, it is determined whether the list-based advertisement will perform relatively well when displayed on the website. For example, in FIG. 3, ad server 304 may determine whether the list-based advertisement will perform relatively well when displayed on the website by comparing the associated performance metric to a second threshold. In an embodiment, the second threshold is determined in a manner substantially similar to the threshold described with reference to step 514. Alternatively, the second threshold may be determined independently of the threshold associated with the web-site based advertisement. As would be appreciated by those skilled in the relevant art(s), whether the list-based advertisement will perform relatively well may be determined in other ways without departing from the scope and spirit of the invention.

If it is determined that the list-based advertisement will not perform relatively well, step 518 is reached. In step 518, the website-based advertisement is displayed. For example, in FIG. 3, ad server 304 may display the website-based advertisement on the website.

If it is determined that the list-based advertisement will perform relatively well, step 520 is reached. In step 520, the website-based advertisement is displayed. For example, in FIG. 3, ad server 304 may display either the website-based advertisement or both the website-based advertisement and the list-based advertisement on the website.

Returning to step 514, if it is determined that the website-based advertisement will not perform relatively well, step 522 is reached. Step 522 is generally similar to step 516 described above except that if it is determined that the list-based advertisement will perform relatively well step 524 is reached, if not, step 520 is reached.

In step 524, the list-based advertisement is displayed. For example, in FIG. 3, ad server 304 may display the list-based advertisement on the website.

In optional step 526, content representative of a second future event is displayed in addition to the displayed advertisement. In an embodiment, content representative of a second future event may include information that is relevant to a current time period and information that is relevant to a future time period. For example, tasks may include tasks to be completed in a current week and tasks that are to be completed the following week. In such an embodiment, a to-do list (e.g., to-do list 700) may be configured to display tasks that are relevant to the current period of time (e.g., tasks to be completed during the current week). In a further embodiment, the to-do list may be updated with tasks to be completed the following week when the current week has expired.

In an embodiment, optional step 526 results in content representative of a second future event that is relevant to a future time period being displayed. For example, optional step 526 may result in the to-do list displaying tasks that are relevant to a future period of time (e.g., the next week) in addition to or instead of tasks that are currently displayed. In alternate embodiments, content representative of the second future event may be displayed as content on the webpage the user is visiting.

In an embodiment, optional step 526 may be executed if it is determined that displaying content representative of the second future event may increase the user's interest in an advertisement currently being displayed. For example, it may be determined that information regarding the second future event has an associated characteristic that is relevant to an advertisement descriptor of the advertisement currently being displayed (e.g., a website-based advertisement, list-based advertisement, or other type of advertisement). In such an embodiment, displaying the content representative of the second future event may increase the user's interest in the advertisement currently being displayed. In an alternate embodiment, optional step 526 may be executed if it is determined that both the list-based advertisement and the website-based advertisement will not perform well. In such an embodiment, the content representative of the second future event may also increase the user's interest in the advertisement being displayed.

Thus, as described in method 500, an advertisement relevant to a user's interest (e.g., a website-based advertisement) and/or an advertisement relevant to a future event associated with the user (e.g., a list-based advertisement) may be displayed. One of skill in the art will recognize that other comparisons may be made to determine whether a website-based advertisement or a list-based advertisement (or both) will appear on the website. In the example of FIG. 5, if both the website-based advertisement and the list-based advertisement perform well, the website-based advertisement is displayed. However, in an alternate embodiment, the list-based advertisement may be displayed if both the website-based advertisement and the list-based advertisement perform well. In yet another embodiment, both the website-based advertisement and the list-based advertisement may be displayed on the website if both perform well and there is sufficient space allocated to advertisements on the website. Similarly, in the example of FIG. 5, if both the website-based advertisement and the list-based advertisement perform poorly, the website-based advertisement is displayed. In an alternate embodiment, the list-based advertisement may be displayed if both the website-based advertisement and the list-based advertisement perform poorly. In yet another embodiment, both the website-based advertisement and the list-based advertisement may be displayed on the website if both perform poorly and there is sufficient space allocated to advertisements on the website.

In alternate embodiments, the advertisement relevant to the user's interest as well as the advertisement relevant to a future event may be determined in other ways. For example, as described with reference to FIG. 1, an advertisement relevant to one or more interests of the user may be determined based on user provided information. In such an embodiment, content analyzer 308 may be configured to function in a manner similar to user provided information analyzer 110 when provided with user provided information.

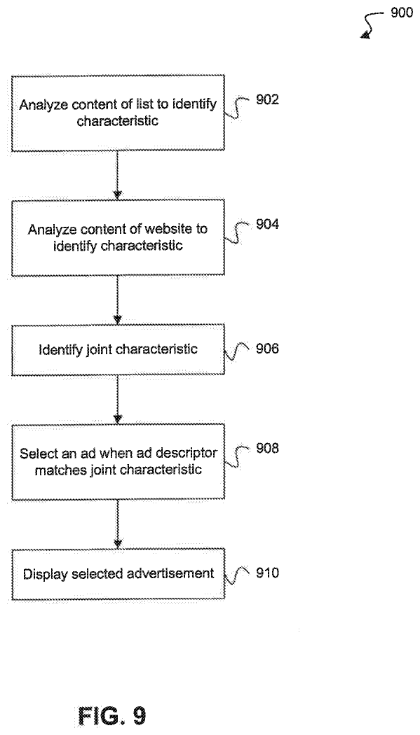

As shown in FIG. 9, an exemplary method 900 for providing an advertisement on a website is provided, according to an embodiment of the present invention. As would be apparent to those skilled in the relevant art(s), such a method may be automated through the use of hardware, software, firmware, or any combination thereof. Method 900 will be described with reference to the embodiment in which advertisements are provided to a user who is visiting a website through suitable interaction with system 300 shown in FIG. 3, but is not limited in that regard.

Method 900 begins with step 902. In step 902, the content of a list or other information regarding a future event is analyzed to identify one or more characteristics. In an embodiment, the operation of step 902 is substantially similar to the operation of step 502 described with respect to method 500.

In step 904, the content of the website is analyzed to identify a characteristic of the website. In an embodiment, the operation of step 904 is substantially similar to the operation of step 508, described with respect to method 500.

In step 906, one or more joint characteristics are identified. For example, ad server 304 may compare a group of characteristics of to-do list 700 and/or shopping list 800 with a group of characteristics of the website to identify joint characteristics.

In an embodiment, a joint characteristic may be a characteristic that is found in the characteristics of the user-sourced information regarding the future event and in the characteristics of the website. In alternate embodiments, a joint Characteristic may be a characteristic of the user-sourced information regarding the future event that is relevant to a characteristic of the website or vice versa. In a further embodiment, a relevance between characteristics may be determined by ad server 304. For example, if “groceries” is identified as a characteristic of the user-sourced information and “milk” is identified as a characteristic of the website, ad server 304 may identify the characteristics as being relevant so that “groceries” and/or “milk” may be identified as joint characteristics.

In step 908, an advertisement relevant to one or more joint characteristics is selected. For example, ad server 304 may select an advertisement that has one or more descriptors that match one or more joint characteristics.

In step 908, the selected advertisement is displayed. For example, ad server 304 may display the selected advertisement on the website.

Aspects of the present invention, for example method 400, method 500, and/or method 900 or system 300 or any part(s) or function(s) thereof may be implemented using hardware, software, firmware, or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

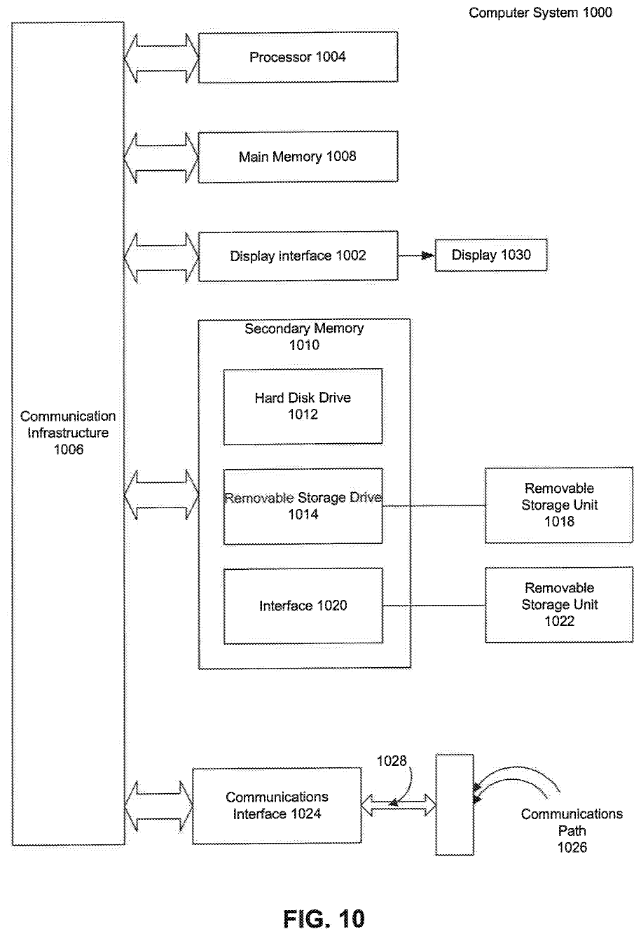

In fact, in one embodiment, the invention is directed toward one or more computer systems capable of carrying out the functionality described herein. An example of a computer system 1000 is shown in FIG. 10.

The computer system 1000 includes one or more processors, such as processor 1004. The processor 1004 is connected to a communication infrastructure 1006 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 1000 can include a display interface 1002 that forwards graphics, text, and other data from the communication infrastructure 1006 (or from a frame buffer not shown) for display on the display unit 1030.

Computer system 1000 also includes a main memory 1008, preferably random access memory (RAM), and may also include a secondary memory 1010. The secondary memory 1010 may include, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well known manner. Removable storage unit 1018 represents a floppy disk, magnetic tape, optical disk, etc. which is read by and written to by removable storage drive 1014. As will be appreciated, the removable storage unit 1018 includes a computer usable storage medium having stored therein computer software and/or data.

In alternative embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, which allow software and data to be transferred from the removable storage unit 1022 to computer system 1000.

Computer system 1000 may also include a communications interface 1024. Communications interface 1024 allows software and data to be transferred between computer system 1000 and external devices, Examples of communications interface 1024 may include a modem, a network interface (such as an Ethernet card), a communications port, a Personal Computer Memory Card International Association (PCMCIA) slot and card, etc. Software and data transferred via communications interface 1024 are in the form of signals 1028 which may be electronic, electromagnetic, optical or other signals capable of being received by communications interface 1024. These signals 1028 are provided to communications interface 1024 via a communications path (e.g., channel) 1026. This channel 1026 carries signals 1028 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 1014 and a hard disk installed in hard disk drive 1012. These computer program products provide software to computer system 1000. The invention is directed to such computer program products.

Computer programs (also referred to as computer control logic) are stored in main memory 1008 and/or secondary memory 1010. Computer programs may also be received via communications interface 1024. Such computer programs, when executed, enable the computer system 1000 to perform the features of the present invention, as discussed herein. In particular, the computer programs, when executed, enable the processor 1004 to perform the features of the present invention. Accordingly, such computer programs represent controllers of the computer system 1000.

In an embodiment where the invention is implemented using software, the software may be stored in a computer program product and loaded into computer system 1000 using removable storage drive 1014, hard drive 1012 or communications interface 1024. The control logic (software), when executed by the processor 1004, causes the processor 1004 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. (canceled)

2. A method, comprising:
identifying, by one or more processors, an event that is specified in a calendar entry of a calendar that is maintained by a user, wherein a scheduled time of the calendar entry is in the future;
identifying, by one or more processors, first characteristics of the event within the calendar entry;
identifying, by one or more processors, second characteristics of online information previously accessed by the user;
determining, by one or more processors, one or more joint characteristics that are included in both of (i) the first characteristics of the event within the calendar entry and (ii) the second characteristics of the online information previously accessed by the user; and
selecting, by one or more processors, audio information having a descriptor that matches the one or more joint characteristics that are included in both of (i) the first characteristics of the event within the calendar entry and (ii) the second characteristics of the online information previously accessed by the user;
delivering, to the user by one or more processors, the audio information based on the one or more joint characteristics matching the descriptor that describes the audio information.

3. The method of claim 2, comprising:
determining that a time of the event specified by the calendar entry has passed; and
discontinuing delivery of information about a product or service in response to determining that the time of the event has passed.

4. The method of claim 2, comprising:
identifying a task on a to-do list that is maintained by the user; and
delivering information about a product or service relevant to the task based on the task being identified on the to-do list.

5. The method of claim 4, comprising:
obtaining an updated to-do list of the user;
determining that the task has been completed based on the updated to-do list; and
discontinuing delivery of the information about the product or service in response to determining that the task has been completed.

6. The method of claim 4, comprising:
obtaining an updated to-do list of the user;
determining that the task has been completed based on the updated to-do list;
determining that the task is a recurring task performed by the user; and
continuing delivery of the information about the product or service in response to determining that the task is a recurring task performed by the user even though the task has been completed.

7. The method of claim 2, comprising delivering information relevant to a subsequent event that is specified in a subsequent calendar entry having a date that is after the event, wherein the information relevant to the subsequent event is delivered for presentation with the audio information.

8. The method of claim 2, comprising:
identifying a location of the user, wherein:
delivering audio information comprises delivering audio information based on the one or more joint characteristics matching descriptors that describe the audio information as well as the location of the user matching a location descriptor assigned to the audio information.

9. A system, comprising:
a user-sourced information database storing a calendar that is maintained by a user; and
one or more processors that interact with the user-sourced information database and perform operations including:
identifying an event that is specified in a calendar entry of the calendar that is maintained by the user, wherein a scheduled time of the calendar entry is in the future;
identifying first characteristics of the event within the calendar entry;
identifying second characteristics of online information previously accessed by the user;
selecting determining one or more joint characteristics that are included in both of (i) the first characteristics of the event within the calendar entry and (ii) the second characteristics of the online information previously accessed by the user; and
selecting audio information having a descriptor that matches the one or more joint characteristics that are included in both of (i) the first characteristics of the event within the calendar entry and (ii) the second characteristics of the online information previously accessed by the user;
delivering, to the user, the audio information based on the one or more joint characteristics matching the descriptor that describes the audio information.

10. The system of claim 9, wherein the one or more processors perform operations comprising:
determining that a time of the event specified by the calendar entry has passed; and
discontinuing delivery of information about a product or service in response to determining that the time of the event has passed.

11. The system of claim 9, wherein the one or more processors perform operations comprising:
identifying a task on a to-do list that is maintained by the user; and
delivering information about a product or service relevant to the task based on the task being identified on the to-do list.

12. The system of claim 11, wherein the one or more processors perform operations comprising:
obtaining an updated to-do list of the user;
determining that the task has been completed based on the updated to-do list; and
discontinuing delivery of the information about the product or service in response to determining that the task has been completed.

13. The system of claim 11, wherein the one or more processors perform operations comprising:
obtaining an updated to-do list of the user;
determining that the task has been completed based on the updated to-do list;
determining that the task is a recurring task performed by the user; and
continuing delivery of the information about the product or service in response to determining that the task is a recurring task performed by the user even though the task has been completed.

14. The system of claim 9, wherein the one or more processors perform operations comprising delivering information relevant to a subsequent event that is specified in a subsequent calendar entry having a date that is after the event, wherein the information relevant to the subsequent event is delivered for presentation with the audio information.

15. The system of claim 9, wherein the one or more processors perform operations comprising:
identifying a location of the user, wherein:
delivering audio information comprises delivering audio information based on the one or more joint characteristics matching descriptors that describe the audio information as well as the location of the user matching a location descriptor assigned to the audio information.

16. A non-transitory computer readable medium storing instructions that, when executed by one or more processors, cause the one or more processors to perform operations comprising:
identifying an event that is specified in a calendar entry of a calendar that is maintained by a user, wherein a scheduled time of the calendar entry is in the future;
identifying first characteristics of the event within the calendar entry;
identifying second characteristics of online information previously accessed by the user;
determining one or more joint characteristics that are included in both of (i) the first characteristics of the event within the calendar entry and (ii) the second characteristics of the online information previously accessed by the user; and
selecting audio information having a descriptor that matches the one or more joint characteristics that are included in both of (i) the first characteristics of the event within the calendar entry and (ii) the second characteristics of the online information previously accessed by the user;
delivering, to the user, the audio information based on the one or more joint characteristics matching the descriptor that describes the audio information.

17. The non-transitory computer readable medium of claim 16, wherein the instructions cause the one or more processors to perform operations comprising:
determining that a time of the event specified by the calendar entry has passed; and
discontinuing delivery of information about a product or service in response to determining that the time of the event has passed.

18. The non-transitory computer readable medium of claim 16, wherein the instructions cause the one or more processors to perform operations comprising:
identifying a task on a to-do list that is maintained by the user; and
delivering information about a product or service relevant to the task based on the task being identified on the to-do list.

19. The non-transitory computer readable medium of claim 18, wherein the instructions cause the one or more processors to perform operations comprising:
obtaining an updated to-do list of the user;
determining that the task has been completed based on the updated to-do list; and
discontinuing delivery of the information about the product or service in response to determining that the task has been completed.

20. The non-transitory computer readable medium of claim 18, wherein the instructions cause the one or more processors to perform operations comprising:
obtaining an updated to-do list of the user;
determining that the task has been completed based on the updated to-do list;
determining that the task is a recurring task performed by the user; and
continuing delivery of the information about the product or service in response to determining that the task is a recurring task performed by the user even though the task has been completed.

21. The non-transitory computer readable medium of claim 16, wherein the instructions cause the one or more processors to perform operations comprising delivering information relevant to a subsequent event that is specified in a subsequent calendar entry having a date that is after the event, wherein the information relevant to the subsequent event is delivered for presentation with the audio information.
